(19) United States
(12) Patent Application Publication
(10) Pub. No.: US 2026/0349857 A1
(43) Pub. Date: Nov. 5, 2026

(54) ARTIFICIAL INTELLIGENCE ANALYSIS FOR HOLISTIC SYSTEM DESIGN

(71) Applicant: Microsoft Technology Licensing, LLC, Redmond, WA (US)

(72) Inventors: Behnaz ARZANI, Woodinville, WA (US); Pooria NAMYAR, Los Angeles, CA (US); Roozbeh BOSTANDOOST, Amherst, MA (US); Rodrigo Lopes Cancado FONSECA, Bothel, WA (US); Siva Kesava Reddy KAKARLA, Redmond, WA (US); Ryan Andrew BECKETT, Bellevue, WA (US); Tsu-wang HSIEH, Sammamish, WA (US); Ankur MALLICK, Bellevue, WA (US)

(21) Appl. No.: 19/194,443

(22) Filed: Apr. 30, 2025

(51) Int. Cl. G06F 11/00; G06F 9/455

(52) U.S. Cl. CPC G06F 11/008; G06F 9/45558; G06F 2009/4557; G06F 2201/805

(57) ABSTRACT

The present disclosure relates to systems and methods for analyzing machine learning models deployed within a system. The systems and methods approximate the machine learning models as heuristics and analyze the end-to-end performance impact of the machine learning models using heuristic performance analyzers. The systems and methods provide an output of the analysis of the system performance.

### BACKGROUND

Machine learning based solutions are used in systems to improve the availability and efficiency of resources keeping up with the increasing demand for resources. However, existing solutions lack the tools necessary to understand the impact of the machine learning models deployed on each-other and on the end-to-end performance of the systems the machine learning models are deployed in.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes receiving a query for a plurality of machine learning models operating within a system. The method includes analyzing a performance of the system by modeling each machine learning model of the plurality of machine learning models as a different heuristic, and the query. The method includes providing a query response to the query in response to analyzing the performance of the system.

Some implementations relate to a device including a memory to store data and instructions; and a processor operable to communicate with the memory, wherein the processor is operable to: receive a query for a plurality of machine learning models operating within a system; analyze a performance of the system by modeling each machine learning model of the plurality of machine learning models as a different heuristic, and the query; and provide a query response to the query in response to analyzing the performance of the system.

Some implementations relate to a computer-readable storage medium including instructions that, when executed by a processor, cause the processor to: receive a query for a plurality of machine learning models operating within a system; analyze a performance of the system by modeling each machine learning model of the plurality of machine learning models as a different heuristic, and the query; and provide a query response to the query in response to analyzing the performance of the system.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for using a machine learning model analysis tool in accordance with implementations of the present disclosure.

FIG. 2 illustrates example queries supported by a machine learning model analysis tool in accordance with implementations of the present disclosure.

FIG. 3 illustrates an example environment for using a machine learning model analysis tool in accordance with implementations of the present disclosure.

FIG. 4 illustrates an example method for machine learning model analysis in accordance with implementations of the present disclosure.

FIG. 5 illustrates components that may be included within a computer system in accordance with implementations of the present disclosure.

### DETAILED DESCRIPTION

This disclosure generally relates to machine learning model analysis. Machine learning based solutions are used in systems to improve the availability and efficiency of resources keeping up with the increasing demand for resources. However, existing solutions lack the tools necessary to understand the impact of the machine learning models deployed on each-other and on the end-to-end performance of the systems the machine learning models are deployed in.

Existing tools only enable operators to analyze the behavior of each machine learning model deployed in a system, and a user manually reasons through how the combination of multiple machine learning models may interact with each other and the system. Existing solutions based on empirical analysis or simulations are unable to quantify risks a machine learning model imposes on the system. Doing a simulation of different machine learning models interacting within a system can be time consuming. Simulating all possible permutations of the machine learning models interacting with each other is expensive. Moreover, simulations of machine learning models interacting with each other may miss possible orderings which are all equally likely to happen in practice.

The present disclosure includes systems and methods that provide a machine learning analysis tool enabling a holistic analysis of machine learning models deployed within a system. The systems and methods approximate the machine learning models as heuristics. The systems and methods analyze the end-to-end performance impact of the machine learning models using heuristic performance analyzers. The systems and methods support existing machine learning model queries applying the queries to a multi-model environment and providing an output of the machine learning models analysis.

The present disclosure includes a number of practical applications that provide benefits and/or solve problems associated with machine learning model analysis. Examples of these applications and benefits are discussed in further detail below.

One example benefit of the systems and methods is providing a holistic analysis of machine learning models deployed within a system. Another example benefit of the systems and methods is analyzing an impact on a performance of a system based on interactions among machine learning models operating within the system. Another example benefit of the systems and methods is understanding an impact of the machine learning models on the end-to-end performance and an expected return if improvements or changes are made to the machine learning models or operations of the system.

One technical advantage of the systems and methods of the present disclosure is approximating the machine learning models as heuristics. Modeling the machine learning models as heuristics allows an analysis of interactions among different machine learning models and an analysis of overall system performance. Another technical advantage of the systems and methods of the present disclosure is supporting machine learning analysis queries by converting the queries into heuristics. Another technical advantage of the systems and methods of the present disclosure is scaling the analysis of the machine learning models.

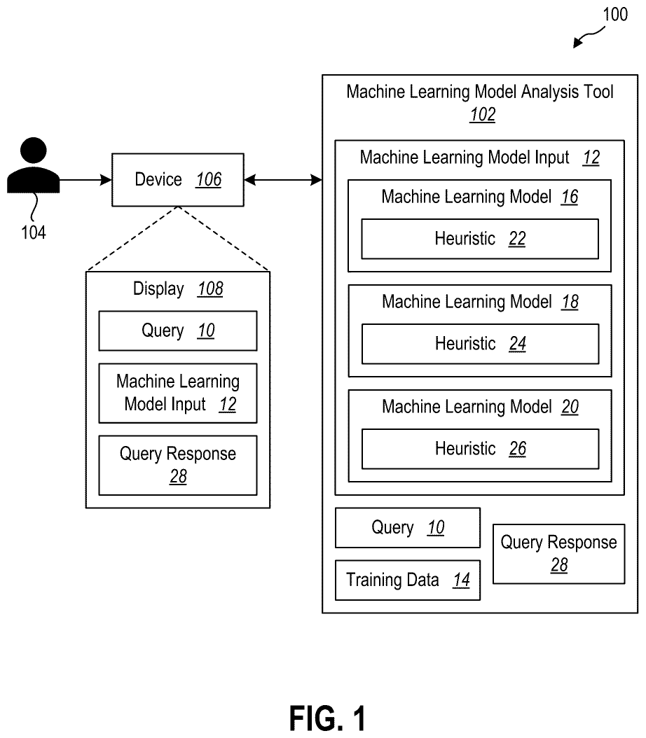

Referring now to FIG. 1, illustrated is an example environment 100 for a machine learning model analysis tool 102 in analyzing machine learning models. In some implementations, a user 104 uses the machine learning model analysis tool 102 in analyzing how the machine learning models used in a system contribute to a performance of a system. One example system is a cloud computing environment that uses a plurality of machine learning models.

A user 104 accesses the machine learning model analysis tool 102 using a device 106. The device 106 may be representative of one or multiple devices and may refer to various types of computing devices. For example, the device 106 may include a mobile device such as a mobile telephone, a smartphone, a personal digital assistant (PDA), a tablet, a laptop, or any other portable device. Additionally, or alternatively, the device 106 may include one or more non-mobile devices such as a desktop computer, server device, or other non-portable device. In some implementations, the device 106 may be communicatively coupled (e.g., wired or wirelessly) to a display 108 having a user interface thereon providing a display of system content.

The machine learning model analysis tool 102 is in communication with the device 106 via a network. In some implementations, the machine learning model analysis tool 102 is on a cloud server remote from the device 106 accessed through the network. For example, the machine learning model analysis tool 102 is hosted on virtual machines in the cloud. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the Internet. The network may facilitate communication between the various computing devices. The server may include one or more computing devices (e.g., including processing units, data storage, etc.) organized in an architecture with various network interfaces for connecting to and providing data management and distribution across one or more client systems. While one device is illustrated, the machine learning model analysis tool 102 may be in communication with a plurality of devices.

In some implementations, the machine learning model analysis tool 102 is accessed through a server address configured to an end point of the machine learning model analysis tool 102 provided to the device 106 that the user 104 may access using a browser on the device 106. Another example includes an application on the device 106 provides access to the machine learning model analysis tool 102.

The user 104 provides a query 10 to the machine learning analysis tool 102 using the device 106. In some implementations, the query 10 includes a question about a worst typical case of the machine learning models under common production workloads in the system. In some implementations, the query 10 includes a question about the impact of change of the machine learning models in the system. In some implementations, the query 10 includes a question about identifying risk areas of the machine learning models in the system. In some implementations, the query 10 includes a question about interactions between the machine learning models in the system. In some implementations, the query 10 includes a question about identifying opportunities for improving the machine learning models in the system.

In some implementations, the user 104 selects the query 10 from a list of queries supported by the machine learning model analysis tool 102. For example, the list of queries includes a set of pre-defined queries that the user 104 may choose from for the analysis of the system. In some implementations, the user 104 provides multiple queries 10 to the machine learning model analysis tool 102. In some implementations, the user 104 provides machine learning model input 12 to the machine learning model analysis tool 102 identifying the machine learning models 16, 18, 20 in the system that the user 104 wants analyzed.

In some implementations, the machine learning model analysis tool 102 is a heuristic performance analyzer. A heuristic performance analyzer takes as input a model of a heuristic algorithm and a benchmark (which is either another heuristic algorithm or an optimal algorithm) as an optimization or as a finite state machine and produce an output that maximizes the performance gap between the two. A heuristic performance analyzer analyzes systems with sequential inputs by analyzing a finite sequence of inputs relying on bounded model checking.

In some implementations, the query 10 is modeled as a heuristic by mapping features of the query 10 to a corresponding ground truth label. For example, the ground truth mappings of the query 10 are encoded into a feature vector in a format that the machine learning model analysis tool 102 supports.

The machine learning model analysis tool 102 receives the query 10, the machine learning model input 12 for the machine learning models operating in the system, and training data 14 and provides a query response 28 to the query 10 based on analyzing the machine learning models operating in the system.

The machine learning model input 12 includes each machine learning model 16, 18, 20 operating in the system. For example, the machine learning model 16 is a lifetime machine learning model, the machine learning model 18 is a central processing unit (CPU) machine learning model, and the machine learning model 20 is a memory machine learning model. While three machine learning models are illustrated, any number of machine learning models may be operating in the system and subject to analysis by the machine learning model analysis tool 102.

In some implementations, the machine learning models are light gradient boost models (LGBM). LGBMs are ensembles of decision trees. LGBMs divide the trees in the ensemble into groups where each group corresponds to a separate class label. The trees within each group compute the likelihood with which a sample belongs to the group's class and the LGBM adds the outputs to compute the group's overall score. The LGBM applies a softmax to the scores to compute the probability for each class and the maximum likelihood prediction.

In some implementations, the machine learning model 16 is modeled as a heuristic 22, the machine learning model 18 is modeled as a heuristic 24, and the machine learning model 20 is modeled as a heuristic 26. In some implementations, the heuristics 22, 24, 26 provide a mathematical model for use by the machine learning model analysis tool 102 in analyzing the machine learning models. The heuristics 22, 24, 26 are in a form which the machine learning model analysis tool 102 understands. The heuristics 22, 24, 26 capture distributions in the machine learning models 16, 18, 20 that the machine learning model analysis tool 102 uses in answering the query 10. For example, the heuristics 22, 24, 26 capture the error distributions of each machine learning model 16, 18, 20. In some implementations, the machine learning model analysis tool 102 analyzes the heuristics 22, 24, 26 in relation to the ground truth labels in the training data 14 to generate a query response 28 to the query 10. In some implementations, the machine learning models 16, 18, 20 are modeled as feasibility/Satisfiability Modulo Theories (SMT) equations.

In some implementations, the machine learning models 16, 18, 20 are modeled as a mixed integer feasibility problem. The stages involved in running inference for an LGBM are (1) each decision tree in the ensemble produces a value based on the feature vector (the score S); (2) the LGBM combines these scores for each class (into a vector P′) and computes a softmax over the scores for each class to produce a probability distribution (for each class i it produces a number 0≤Pᵢ≤1 which is the probability with which sample i belongs to class i); and (3) the LGBM computes the maximum likelihood estimate given this probability distribution.

In some implementations, the softmax computation is skipped for computing the predicted class label and the class with the maximum score, i=argmaxᵢP′ is identified. An indicator variable (one that can only take the values 0 or 1) and shows which index i corresponds to the P′ᵢ which is the highest among all P′ is identified. The binary variable xᵢ enforces constraints that only allow xᵢ=1 if P′ᵢ≥P′ⱼ for all values of j.

One example equation that is used in identifying the class with the maximum score for the LGBM is illustrated below in equation 1.

$$∀ i , j \vert i \neq j {P}_{j}^{′} - {P}_{i}^{′} \leq M ( 1 - {x}_{i} ) \qquad ( 1 )$$

$$\sum {x}_{i} = 1$$

M is a large number and the second sum in the equation (1) ensures that only one class as the output of the LGBM is returned. One example equation that is used in identifying Pᵢ′ is illustrated below in equation 2.

$${P}_{i}^{′} = {\sum }_{i = 0}^{{n}_{c}} {S}_{k \times {n}_{t} + 1} \qquad ( 2 )$$

where n_{c} is the number of classes and nₜ is the number of decision trees per class. To compute the sum, Sⱼ is needed. Sⱼ shows which leaves in each tree are activated and returns the value the trees return at those leaves. In some implementations, a set of constraints are used to identify Sⱼ. For example, the set of constraints restrict the set of leaves that are allowed to be active based on the value of the feature at that node.

One example set of constraints that are used in modeling an inference behavior of an LGBM is illustrated below.

$${\sum }_{i} {a}_{ij} = 1$$

$${\sum }_{i ∈ {ℒ}_{kj}} {a}_{ij} \leq 1 + ϵ ( {T}_{kj} - {f}_{feature ( k )} ) ∀ k$$

$${\sum }_{i ∈ {ℛ}_{kj}} {a}_{ij} \leq 1 + ϵ ( {f}_{feature ( k ) - {T}_{kj} )} - μ ∀ k$$

Where Lₖⱼ and Rₖⱼ are all the leaf nodes to the left and to the right of the k^{th} node in the j^{th} tree. The two values e and/are small numbers. The set of constraints fully model the inference behavior of an LGBM.

In some implementations, the machine learning model analysis tool 102 uses the modeled inference behavior in the heuristics 22, 24, 26 in analyzing the machine learning models 16, 18, 20 interacting with each other within the system in providing the query response 28 to the query 10. In some implementations, the machine learning model analysis tool 102 uses the modeled inference behavior in the heuristics 22, 24, 26 in analyzing an impact of the machine learning models 16, 18, 20 on the system in providing the query response 28 to the query 10.

In some implementations, the machine learning model analysis tool 102 uses the heuristics 22, 24, 26 to find a series of predictions that maximize a gap and to find the set of features that produce those predictions. The machine learning analysis tool 102 for a given set of machine learning models (e.g., the machine learning models 16, 18, 20 operating in the system) find all combinations of predictions that are simultaneously feasible. For example, the machine learning model analysis tool 102 finds scenarios where machine learning model 16 produces prediction a and machine learning model 18 produces prediction b on the same set of features in providing the query response 28.

The machine learning model analysis tool 102 checks an impact of the predictions on the system. For example, the machine learning model analysis tool 102 identifies the sequence of feasible predictions that maximize the objective that corresponds to the query 10 in providing the query response 28. Another example includes the machine learning model analysis tool 102 identifying which sequence of feasible predictions cause the worst-case performance.

The machine learning model analysis tool 102 provides the query response 28 to the device 106. In some implementations, the query response 28 is provided for presentation on the display 108 in response to the query 10. One example includes the query response 28 identifying scenarios when the system performs poorly. Another example includes the query response 28 identifying a machine learning model that operates inefficiently. Another example includes the query response 28 identifying features in a machine learning model that impact system performance. Another example includes the query response 28 identifying an impact on the system performance if a machine learning model is replaced. Another example includes the query response 28 identifying impacts to the performance of the system in response to improvements in a machine learning model.

The user 104 may use the query response 28 in performing an action on the system. One example action is the user 104 replaces a machine learning model in the system with a different machine learning model. Another example action includes the user 104 modifies an operation of the system to prevent scenarios that cause the system to perform poorly. Another example action includes the user 104 retrains a machine learning model in the system. Another example action includes the user 104 bypasses using the machine learning model in the system. Another example action includes the user 104 using a different algorithm with the machine learning model.

The environment 100 provides a holistic analysis of the machine learning models interacting with each other in the system allowing users to use the information provided in the query response 28 in understanding a performance of the system as a whole.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

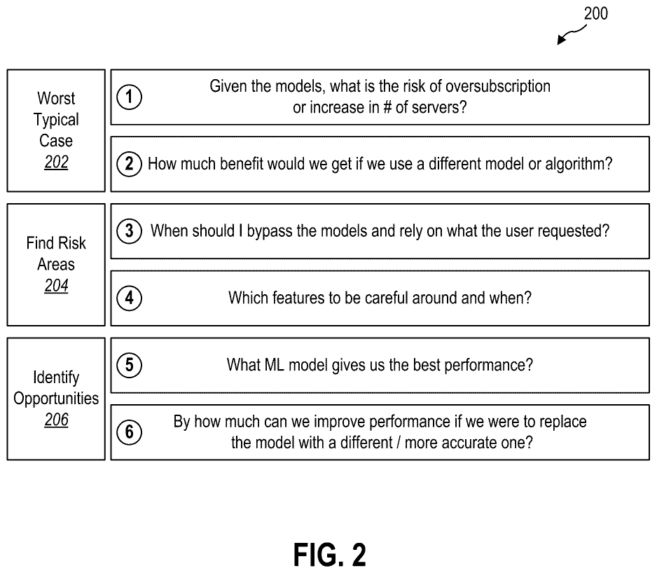

FIG. 2 illustrates example list of queries 200 supported by the machine learning model analysis tool 102 (FIG. 2). In some implementations, the list of queries 200 includes different query classes. One example query class includes a worst typical case query class 202. The worst typical case query class 202 includes queries trying to identify a worst typical case of a system. One example query is “given the machine learning models, what is the risk of oversubscription or increase in the number of servers?” Another example query is “how much benefit would we get if we use a different model or algorithm?” Another example query is “how far is the machine learning based system from the optimal (over typical workloads)?” Another example query is “what is the impact if we replace or augment a (deployed) algorithm with a machine learning model or vice versa?”

In some implementations, the queries in the worst typical case query class 202 quantify how far the machine learning model augmented system is from an optimal operation workload. In some implementations, the queries in the worst typical case query class 202 quantify an impact of replacing a deployed machine learning model or a deployed algorithm in the system. For example, the queries identify whether a reduction may occur in a risk of oversubscription if a machine learning model or deployed algorithm is replaced in the system.

Another example query class includes an identify risk areas query class 204. The identify risk areas query class 204 includes queries trying to identify risk areas of the machine learning models or the system. One example query is “when should I bypass the machine learning models and rely on what the user requested?” Another example query is “which features to be careful around and when?” Another example query is “when and under what conditions does the machine learning based system under-perform?” Another example query is “in which area of the ‘collective’ feature-space does the system under-perform? Which features contribute to this impact the most?” The queries in the risk area query class 204 help users understand the area in the feature space that causes the system to under-perform.

In some implementations, the queries in the identify risk areas query class 204 identify under which conditions the machine learning model system underperforms. In some implementations, the queries in the identify risk areas query class 204 identify in which area of the collective feature space the system underperforms and which features contribute to this impact the most.

Another example query class includes an identify opportunities query class 206. The identify opportunities query class 206 includes queries identifying opportunities to improve. One example query is “what machine learning model gives the best performance?” Another example query is “by how much can performance improve if we replace the machine learning model with a different/more accurate machine learning model?” Another example query is “how much improvement will we get if we improve the accuracy of a machine learning model or replace it with partially known characteristics?” The queries identifying opportunities to improve help users understand whether improvements can be made to the system and by how much the users can improve the efficiency of the system.

In some implementations, the queries in the identify opportunities query class 206 identify opportunities for system improvement or reducing resources needed in the system by making changes. In some implementations, the queries in the identify opportunities query class 206 quantify how much improvement may occur in response to improving an accuracy of a machine learning model or replacing a machine learning model. For example, the queries identify whether a number of virtual machines used in the system can be reduced if the CPU prediction machine learning model accuracy improves by 10%.

Another example query class of the list of queries 200 includes an impact of the change query class that includes queries that quantify an impact of a change to a machine learning model or the system. One example query includes “how robust is the system to data drift?” Another example query includes “should we retrain the machine learning models more frequently?” Another example query includes “how much data-drift can the machine learning augmented system tolerate?”

Another example query class of the list of queries 200 includes an interaction between machine learning model query class that includes queries that identify an impact of interactions between machine learning models in the system. One example query includes “which of the deployed models cause the worst (typical) case behavior of the system and when?” Another example query includes “how should I re-design/replace the algorithms that interact with the machine learning models to improve performance guarantees?” Another example query includes “how do different machine learning model variants impact the end-to-end performance of the system?”

In some implementations, the user 104 (FIG. 1) selects a query 10 (FIG. 1) from the list of queries 200 to provide to the machine learning model analysis tool 102. The query responses 28 (FIG. 1) provided by the machine learning model analysis tool 102 helps the user 104 in making decisions about the system. For example, whether improvements can be made to an efficiency of the system and whether changes may need to be made to the machine learning models or algorithms operating in the system. The list of queries 200 enable users to prioritize where to spend time and resources in improving an overall performance of the system.

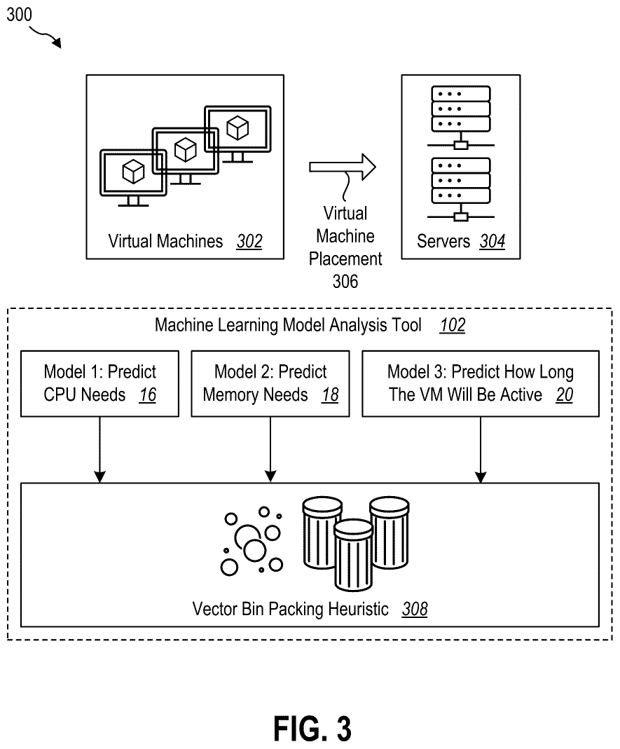

FIG. 3 illustrates an example environment 300 for using the machine learning model analysis tool 102. In some implementations, the environment 300 is a cloud environment using multiple machine learning models 16, 18, 20 to pack virtual machines 302 onto servers 304 in the environment 300. The machine learning models 16, 18, 20 predicts a number of resources an incoming virtual machine request 306 requires and how long a virtual machine will remain active. For example, the machine learning model 16 predicts CPU needs of the virtual machine, the machine learning model 18 predicts memory needs of the virtual machine, and the machine learning model 20 predicts how long a virtual machine will be active.

In some implementations, the predictions of the machine learning models 16, 18, 20 feed into a virtual machine allocator that uses the predictions in assigning the virtual machines 302 to the servers 304 based on a variant of the best fit of a bin packing heuristic 308. Inaccurate machine learning models may under or over-predict the number of resources a virtual machine needs or mis-predict how long the virtual machine may be active, resulting in using more servers or causing performance degradation for the customer if a live migration of the virtual machine to a different server occurs.

In some implementations, the user 104 (FIG. 1) provides a query 10 (FIG. 1) to the machine learning model analysis tool 102 about the environment 300 and uses the query response 28 (FIG. 1) in determining whether to modify how the virtual machines 302 are assigned to the servers 304 or modify another aspect of the environment 300. The machine learning model analysis tool 102 analyzes the machine learning models 16, 18, 20 in the context of the vector bin packing heuristic 308 and determines an impact of the machine learning models 16, 18, 20 on the end-to-end performance of the environment 300 and provides a query response 28.

One example includes the user 104 provides a query 10 selected from worst typical case query class 202 (FIG. 2) to the machine learning model analysis tool 102 and uses the query response 28 in quantifying the risk of over-subscription. For example, the user 104 increases a number of servers 304 in the environment 300. Another example includes the user 104 uses a different machine learning model and reduces the number of servers 304 in the environment 300.

Another example includes the user 104 provides a query 10 selected from an impact of change service class and uses the query response 28 in determining when to retrain the machine learning models 16, 18, 20. Another example includes the user 104 provides a query 10 selected from an identify risk areas query class 204 (FIG. 2) and uses the query response 28 to determine when to by-pass the machine learning models 16, 18, 20 in the environment 300.

Another example includes the user 104 provides a query 10 selected from the interaction between machine learning models class and uses the query response 28 in determining which machine learning placement heuristic (best fit, first fit) is more resilient to mispredictions by the machine learning models 16, 18, 20. Another example includes the user 104 provides a query 10 selected from the interaction between models class and uses the query response 28 in determining whether to use linear regression or a LGBM machine learning model in the environment 300.

Another example includes the user 104 provides a query selected from the identify opportunities query class 206 (FIG. 2) and uses the query response 28 in determining an amount of reduction for live-migrating virtual machines if the number of virtual machines is reduced and an accuracy of the CPU prediction machine learning model is improved by 10%.

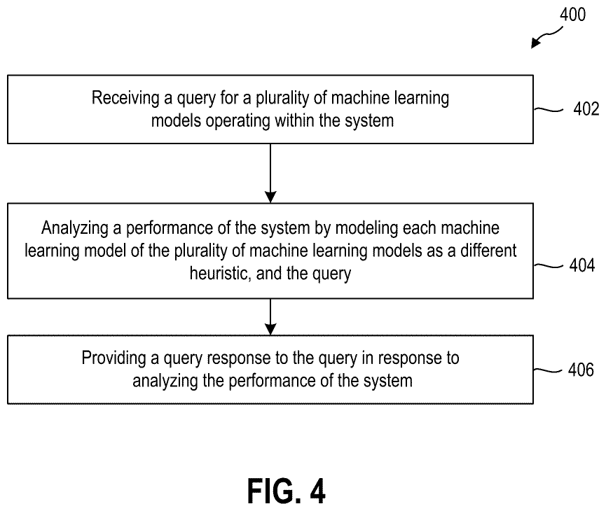

FIG. 4 illustrates an example method 400 for machine learning model analysis. The actions of the method 400 are discussed below in reference to FIGS. 1-3.

At 402, the method 400 includes receiving a query for a plurality of machine learning models operating within the system. In some implementations, the machine learning model analysis tool 102 receives a query 10 for a plurality of machine learning models operating within the system. It should be appreciated that any number of machine learning models may be operating within the system. In some implementations, the query 10 is converted into a query heuristic by encoding ground truth features of the query into a feature vector. In some implementations, the query 10 is selected from a predefined list of queries 200 that include queries that identify a worst typical case of the system, queries that identify risk areas of the system, or queries that identify opportunities for improvement in the system.

At 404, the method 400 includes analyzing a performance of the system by modeling each machine learning model of the plurality of machine learning models as a different heuristic. In some implementations, the machine learning model analysis tool 102 models each machine learning model (e.g., the machine learning model 16, the machine learning model 18, and the machine learning model 20) of the plurality of machine learning models as a different heuristic (e.g., the heuristic 22, the heuristic 24, the heuristic 26). For example, the machine learning model analysis tool 102 models the machine learning model 16 as the heuristic 22. In some implementations, the heuristic 22 captures distributions of the machine learning model 16 and the distributions are used in analyzing the performance of the system. For example, the distributions include an error distribution, and the error distribution is used in analyzing the performance of the system. In some implementations, the machine learning model 16 is modeled as a mixed integer feasibility problem in the heuristic 22.

Another example includes the machine learning model analysis tool 102 models the machine learning model 18 as the heuristic 24. In some implementations, the heuristic 24 captures distributions of the machine learning model 20 and the distributions are used in analyzing the performance of the system. For example, the distributions include an error distribution, and the error distribution is used in analyzing the performance of the system. In some implementations, the machine learning model 18 is modeled as a mixed integer feasibility problem in the heuristic 24.

Another example includes the machine learning model analysis tool 102 models the machine learning model 20 as the heuristic 26. In some implementations, the heuristic 26 captures distributions of the machine learning model 20 and the distributions are used in analyzing the performance of the system. For example, the distributions include an error distribution, and the error distribution is used in analyzing the performance of the system. In some implementations, the machine learning model 20 is modeled as a mixed integer feasibility problem in the heuristic 26.

In some implementations, the machine learning model analysis tool 102 analyzes a performance of the system by modeling each machine learning model of the plurality of machine learning models as a different heuristic, and the query 10. For example, the machine learning model analysis tool 102 uses heuristic performance analyzers in analyzing the performance of the system. In some implementations, the machine learning model analysis tool 102 uses the modeled inference behavior in analyzing an interaction of the plurality of machine learning models in determining the performance of the system.

At 412, the method 400 includes providing a query response to the query in response to analyzing the performance of the system. In some implementations, the machine learning model analysis tool 102 provides a query response 28 in response to analyzing the performance of the system.

In some implementations, the method 400 includes performing an action that modifies the system in response to the query response 28. For example, the user 104 uses the information in the query response 28 to perform an action on the system. Example actions include modifying an operation of the system, removing a machine learning model from the system, replacing a machine learning model in the system with a different machine learning model, or bypassing use of a machine learning model in the system.

In some implementations, a first machine learning model of the plurality of machine learning models predicts a central processing unit need of a virtual machine 302 in the system, a second machine learning model of the plurality of machine learning models predicts a memory need of a virtual machine 302 in the system, and a third machine learning model of the plurality of machine learning models predicts a length of activeness of a virtual machine 302 in the system, and the query response 28 is used to assign the virtual machine 302 to a server 304 in the system.

The method 400 analyzes the end-to-end system performance impact of the plurality of machine learning models deployed within a system.

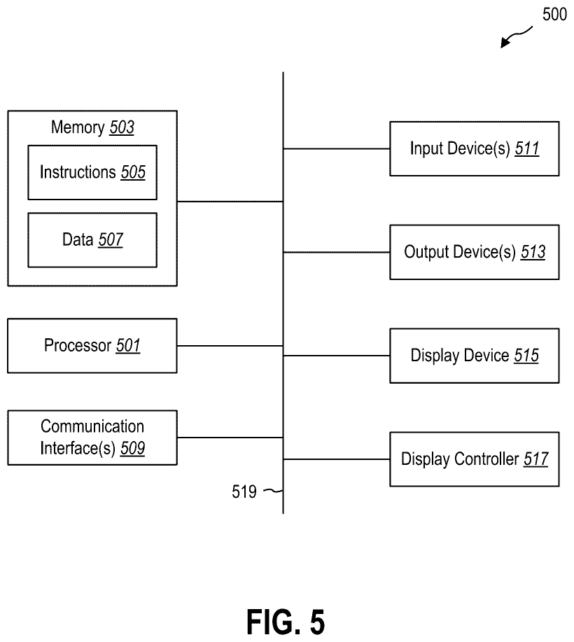

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included within the processor, erasable programmable read-only memory (EPROM), electrically erasable programmable read-only memory (EEPROM), registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

In some implementations, the various components of the computer system 500 are implemented as one device. For example, the various components of the computer system 500 are implemented on a mobile phone or tablet. Another example includes the various components of the computer system 500 implemented on a personal computer. Another example includes the various components of the computer system 500 implemented on the cloud. Another example includes the various components of the computer system 500 implemented on an edge device.

As illustrated in the foregoing discussion, the present disclosure utilizes a variety of terms to describe features and advantages of the systems and methods. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)) or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining, and the like. Also, “determining” can include receiving (e.g., receiving information), accessing (e.g., accessing data in a memory), and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method comprising:
receiving a query for a plurality of machine learning models operating within a system;
analyzing a performance of the system by modeling each machine learning model of the plurality of machine learning models as a different heuristic, and the query; and
providing a query response to the query in response to analyzing the performance of the system.

2. The method of claim 1, further comprising:
performing an action that modifies the system in response to the query response.

3. The method of claim 2, wherein the action includes modifying an operation of the system, removing a machine learning model from the system, replacing machine learning model in the system with a different machine learning model, or bypassing use of a machine learning model in the system.

4. The method of claim 1, wherein the different heuristics capture distributions of each machine learning model and the distributions are used in analyzing the performance of the system.

5. The method of claim 1, wherein the different heuristics capture an error distribution of each machine learning model, and the error distribution is used in analyzing the performance of the system.

6. The method of claim 1, wherein each machine learning model is modeled as a mixed integer feasibility problem in the different heuristics.

7. The method of claim 1, wherein the different heuristics use modeled inference behavior in analyzing an interaction of the plurality of machine learning models in determining the performance of the system.

8. The method of claim 1, wherein the query is converted into a heuristic by encoding ground truth features of the query into a feature vector.

9. The method of claim 1, wherein the query is selected from a predefined list of queries that include queries that identify a worst typical case of the system, queries that identify risk areas of the system, or queries that identify opportunities for improvement in the system.

10. The method of claim 1, wherein a first machine learning model of the plurality of machine learning models predicts a central processing unit need of a virtual machine in the system, a second machine learning model of the plurality of machine learning models predicts a memory need of a virtual machine in the system, and a third machine learning model of the plurality of machine learning models predicts a length of activeness of a virtual machine in the system and the query response is used to assign the virtual machine to a server in the system.

11. A device comprising:
a memory to store data and instructions; and
a processor operable to communicate with the memory, wherein the processor is operable to:
receive a query for a plurality of machine learning models operating within a system;
analyze a performance of the system by modeling each machine learning model of the plurality of machine learning models as a different heuristic, and the query; and
provide a query response to the query in response to analyzing the performance of the system.

12. The device of claim 11, wherein the processor is further operable to perform an action that modifies the system in response to the query response.

13. The device of claim 12, wherein the action includes modifying an operation of the system, removing a machine learning model from the system, replacing machine learning model in the system with a different machine learning model, or bypassing use of a machine learning model in the system.

14. The device of claim 11, wherein the different heuristics capture distributions of each machine learning model, and the distributions are used in analyzing the performance of the system.

15. The device of claim 11, wherein the different heuristics capture an error distribution of each machine learning model, and the error distribution used in analyzing the performance of the system.

16. The device of claim 11, wherein each machine learning model is modeled as a mixed integer feasibility problem in the different heuristics.

17. The device of claim 11, wherein modeling the different heuristics use modeled inference behavior in analyzing an interaction of the plurality of machine learning models in determining the performance of the system.

18. The device of claim 11, wherein the query is converted into a query heuristic by encoding ground truth features of the query into a feature vector.

19. The device of claim 11, wherein the query is selected from a predefined list of queries that include queries that identify a worst typical case of the system, queries that identify risk areas of the system, or queries that identify opportunities for improvement in the system.

20. The device of claim 11, wherein a first machine learning model of the plurality of machine learning models predicts a central processing unit need of a virtual machine in the system, a second machine learning model of the plurality of machine learning models predicts a memory need of a virtual machine in the system, and a third machine learning model of the plurality of machine learning models predicts a length of activeness of a virtual machine in the system and the query response is used to assign the virtual machine to a server in the system.
